(19) United States
(12) Patent Application Publication
(10) Pub. No.: US 2021/0306236 A1
(43) Pub. Date: Sep. 30, 2021

(54) SYSTEM AND METHOD FOR TRIAGE MANAGEMENT

(71) Applicant: HCL TECHNOLOGIES LIMITED, New Delhi (IN)

(72) Inventors: Prathameshwar Pratap SINGH, Noida (IN); Shailendra Kumar ROHILLA, Noida (IN); Yogesh GUPTA, Noida (IN); Shiva Kumar SHOLAYAPPAN, Hyderabad (IN)

(73) Assignee: HCL TECHNOLOGIES LIMITED, New Delhi (IN)

(21) Appl. No.: 17/210,389

(22) Filed: Mar. 23, 2021

(30) Foreign Application Priority Data
Mar. 25, 2020 (IN) 202011013062

(51) Int. Cl. H04L 12/24; H04L 12/26; G06N 5/00

(52) U.S. Cl. CPC H04L 41/5074; G06N 5/003; H04L 43/06; H04L 41/507

(57) ABSTRACT

The method for triage management includes obtaining, from multiple sources, activity logs including issues for triage; processing the activity logs using a decision tree configured to output category and priority score associated with each issue; and, for each issue, identifying the relevant resources to resolve the issue based on the category of the issue, the priority score, and attributes of the relevant resources including historical issue resolution data. The method also includes determining a triage activity based on availability of the relevant resources, categories of the issues, and the priority scores. The triage activity includes a sequence for resolving the issues. The method also includes scheduling call for a predetermined time duration based on the availability and the attributes of the relevant resources; and generating a report for the triage activity, including real time information related to the obtained activity logs, the sources, and the sequence of the issues.

### CROSS-REFERENCE TO RELATED APPLICATIONS AND PRIORITY

The present application claims benefit from Indian Patent Application No. 202011013062 filed on 25 Mar. 2020 the entirety of which is hereby incorporated by reference.

### TECHNICAL FIELD

The present disclosure, in general, relates to the field of technology and business process. More particularly, the present disclosure relates to system and method for triage management in the technology and business processes.

### BACKGROUND

Often, the number of issues tracked in a technology and business process workflow tracking system is very large. Team members from the business process dedicated to address and resolve the issues generally use additional workflow tools to define a triage activity for the issues. However, even with such additional workflow tools, prioritizing and resolving the issues can be extremely difficult and tabor intensive.

To that end, triaging becomes a necessary activity to track the issues and plan resolution process among the team members and among various teams. Currently, triaging is done manually and hence demands more time to schedule calls and bring required team members on the call to address the issues. Besides, it becomes challenging to categorize each issue tracked in the workflow tracking system, especially during manual triaging and when little information is available about executions and historical evidences associated with the tracked issues. Since triaging is a repetitive and ongoing time taking activity, there exists a need to leverage the current day triaging process to achieve enhanced and efficient resolution of the tracked issues.

### SUMMARY

Before the present system and method for triage management is described, it is to be understood that the present disclosure is not limited to systems and methods herein, as there can be multiple possible embodiments which are not expressly illustrated or described in the present disclosure. It is also to be understood that the terminologies used in the description is only for the purpose of describing the embodiments and is not intended to limit the scope of the present disclosure. This summary is provided to introduce concepts related to systems and methods for triage management. This summary is not intended to identify essential features of the claimed subject matter nor is it intended for use in determining or limiting the scope of the claimed subject matter.

In one implementation, a method for triage management is provided. The method includes obtaining, by a processor, activity logs from a plurality of sources. Each activity log includes one or more issues for triage. The method also includes processing the activity logs, by the processor, using a decision tree. In said implementation, the decision tree is configured to output a category of each issue in the activity log and a priority score associated with each issue. Further, the method includes identifying, for each issue, by the processor, relevant resources to resolve the issue based on the category of the issue, the priority score associated with the issues, and attributes of the relevant resources. In said implementation, the attributes of the relevant resources include historical issue resolution data. Further, the method includes determining, by the processor, a triage activity based on availability of the identified relevant resources, categories of the issues, and the priority scores associated with the issues. Particularly, the triage activity includes a sequence for resolving the issues, where is sequence is determined based on the priority scores associated with the issues and the availability of the relevant resources. The method also includes scheduling a call, by the processor, for a predetermined time duration based on the availability of the relevant resources, and predetermined time duration is determined based on the attributes of each of the relevant resources. The method also includes generating, by the processor, a report for the triage activity. In said implementation, the report includes real time information related to the obtained activity logs, the plurality of sources, and the sequence of the issues.

In another implementation, a system for triage management is provided. The system includes a memory and a processor coupled to the memory. The processor is configured to execute instructions stored in the memory. The processor is also configured to obtain activity logs from a plurality of sources and process the activity logs using a decision tree. Each activity log includes one or more issues for triage. In said implementation, the decision tree is configured to output a category of each issue in the activity log and a priority score associated with each issue. Further, the processor is configured to identify, for each issue, relevant resources to resolve the issues based on the category of the issue, the priority score associated with the issue, and attributes of the relevant resources. In said implementation, the attributes of the relevant resources include historical issue resolution data. Further, the processor is configured to determine a triage activity based on availability of the identified relevant resources, categories of the issues, and the priority scores associated with the issues. Particularly, the triage activity includes a sequence for resolving the issues, where the sequence is determined based on based on the priority scores associated with the issues and the availability of the relevant resources. The processor is also configured to schedule a call for a predetermined time duration based on the availability of the relevant resources, where the predetermined time duration is determined based on the attributes of the relevant resources. Furthermore, the processor is configured to generate a report for the triage activity. In said implementation, the report includes real time information related to the obtained activity logs, the plurality of sources, and the sequence of the issues.

These and other aspects and features of non-limiting embodiments of the present disclosure will now become apparent to those skilled in the art upon review of the following description of specific non-limiting embodiments of the disclosure in conjunction with the accompanying drawings.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for triage management, in accordance with an embodiment of the present subject matter.

FIG. 2 illustrates an architecture of the system of FIG. 1, in accordance with an embodiment of the present subject matter.

FIG. 3A illustrates a schematic representation of steps executed by the system of FIG. 1, in accordance with an embodiment of the present subject matter.

FIG. 3B illustrates a block diagram of an adhoc arrangement for the system of FIG. 1, in accordance with an embodiment of the present subject matter.

FIG. 4 illustrates a flowchart for a method for triage management, in accordance with an embodiment of the present subject matter.

### DETAILED DESCRIPTION

Some embodiments of the present disclosure, illustrating all its features, will now be discussed in detail. The words “comprising”, “receiving”, “determining”, “assigning”, and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a”, “an” and “the” include plural references unless the context clearly dictates otherwise. The disclosed embodiments of the systems and methods for triage management are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure for triage management is not intended to be limited to the embodiments illustrated, but is to be accorded the widest scope consistent with the principles and features described herein.

In current day scenario, triaging is considered as a necessary activity to track the issues and plan resolution process among the team members and among various teams. Currently, triaging is done manually and hence demands more time to schedule calls and bring required team members on the call to address the issues. Besides, it becomes challenging to categorize each issue tracked in the workflow tracking system, especially during manual triaging and when little information is available about executions and historical evidences associated with the tracked issues. Since triaging is a repetitive and ongoing time taking activity, there exists a need to leverage the current day triaging process to achieve enhanced and efficient resolution of the tracked issues.

The present subject matter addresses the foregoing problems by providing an efficient triage management method and a system implementing the same. Issues reported from several applications are gathered from multiple sources, by a processor, to form an activity log. The gathered issues are categorized and a priority score for each issue in the activity log is tagged with the issue, by the processor. Relevant resources capable of taking ownership of the issue to have the issue resolved are identified, by the processor, based on the category of the issue, the priority score, and attributes of the relevant resources. Further, a triage activity is automatically determined, by the processor, based on the availability of the relevant resources, the category of the issues, and the priority score associated with the issue. The triage activity includes a sequence for resolving the issues. In order to execute the triage activity, triage calls are scheduled based on the availability of the relevant resources and the attributes of the relevant resources. Further, a report is generated, by the processor, to support the triage activity, where the report includes real time information related to the obtained activity logs, information pertaining to sources from which the activity logs are obtained, and the sequence of the issues. All steps described hereinabove are automatically performed by the processor to achieve efficient and enhanced resolution of the issues.

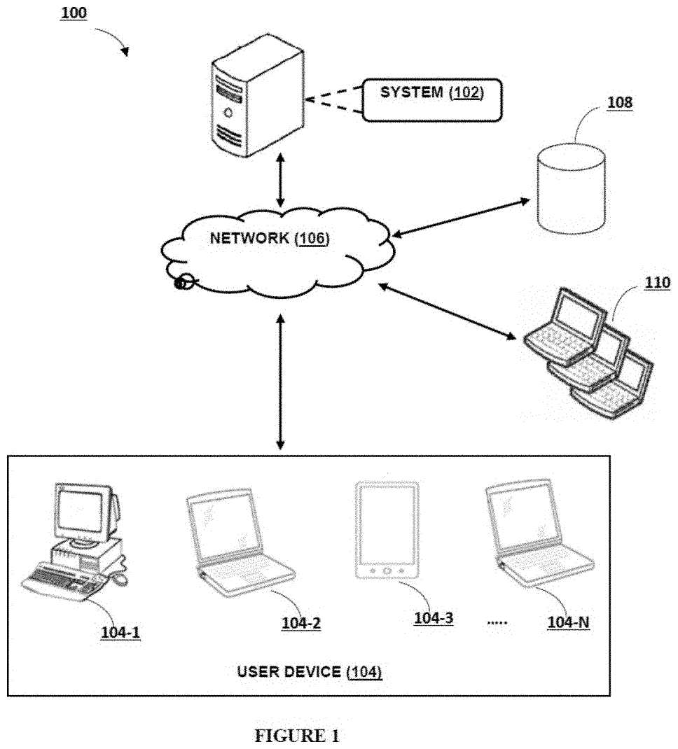

Referring now to FIG. 1, a network implementation 100 of a system 102 for triage management is disclosed. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented over a cloud network. Further, the system 102 is communicably coupled to one or more user devices 104-1, 104-2 . . . 104-N, hereinafter collectively referred to as user device(s) 104, through a network 106. Examples of the user device 104 may include, but are not limited to, a portable computer, a personal digital assistant, a handheld device, and a workstation.

In one implementation, the network 106 may be a wireless network, a wired network or a combination thereof. The network 106 may be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

Further, the system 102 is communicably coupled to a database 108 and one or more resource devices 110 through the network 106. In an example, the database 108 may be implemented as one of a row database, an object-oriented database, a source database, or a column database. Further, the resource devices 110 may be implemented as, but are not limited to, a portable computer, a personal digital assistant, a handheld device, and a workstation. The resource devices 110 are associated with resource personnel (alternatively referred to as ‘resources’) and include availability information and attribute information of the resources. In an embodiment, the availability information may be obtained through applications, such as online calendars of the resource, made available on the resource devices 110. Further, such applications may be configured to track and store the attribute information including historical issue resolution data of the resource.

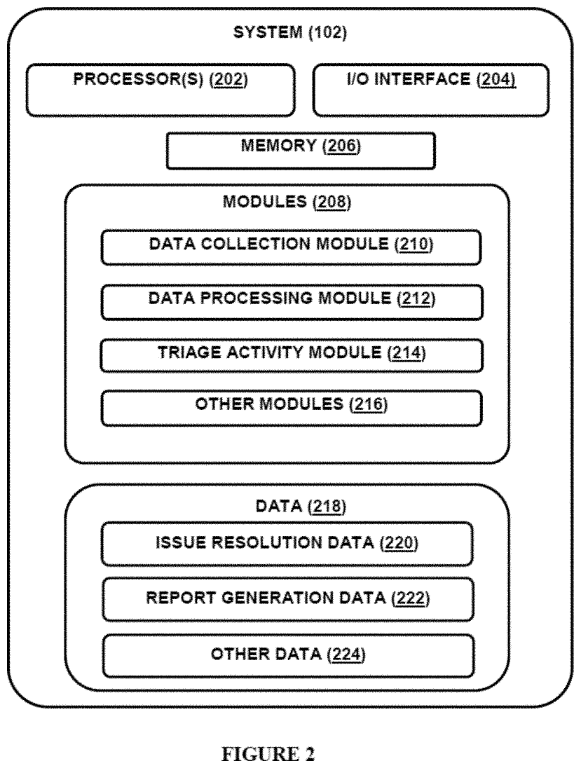

Referring to FIG. 2, configuration of the system 102 is shown. In one embodiment, the system 102 may include at least one processor 202, an input/output (I/O) interface 204, and a memory 206. As used herein, the terms “processor” may be provided using dedicated hardware as well as hardware capable of executing software in association with appropriate software. As such, the processor may include a single dedicated processor, a single shared processor, or a plurality of individual processors, some of which may be shared. Moreover, explicit use of the term “processor” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. In some implementations, the processor 202 may be implemented as one or more microprocessors, microcomputers, microcontrollers, digital signal processors, central processing units, state machines, logic circuitries, and/or any devices that manipulate signals based on operational instructions. Among other capabilities, processor 202 may be configured to fetch and execute computer-readable instructions stored in the memory.

The I/O interface 204 may include a variety of software and hardware interfaces, for example, a web interface, a graphical user interface, and the like. The I/O interface 204 may allow the system 102 to interact with the user directly or through the user device 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting multiple devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory may include data.

The memory 206 is connected to a plurality of modules 208. The modules 208 may be configured within the memory 208 as software modules 208 or the modules 208 may be connected to each of the processor 202, the I/O interface 204 and the memory 206 as hardware modules. In one implementation of the present disclosure, the modules 208 may be embodied as computer readable instructions which, when executed by the processor 202, perform any of the desired functionalities. The machine-readable instructions may be stored on an electronic memory device, hard disk, optical disk, or other machine-readable storage medium or non-transitory medium. In another implementation, the computer-readable instructions can also be downloaded to a storage medium via the network 106.

The modules 208 includes a data collection module 210, a data processing module 212, a triage activity module 214, and other modules 216. The other modules 216 include programs that supplement applications or functions performed by the system 102. The system 102 also includes data 218 that serves, amongst the other things, as a repository for storing data obtained and/or processed by one or more modules 208. The data 218, for example, includes issue resolution data 220, report generation data 222 and other data 224. In an example, the other data 224 may include results of execution of one or more modules in the other modules 216.

FIG. 2 will be described in conjunction with FIG. 1. In an implementation, activity logs are obtained, by the data collection module 210, from multiple sources, such as identity management units, project management units, databases, files, applications, web servers, repositories, and data management units. The activity logs include one or more issues for triage. In an example, the activity logs may include, but not limited to, operating system generated logs and events, application custom logs, and/or application crash logs.

In some implementations, the activity logs may include information associated with issue, such as identity of area of an application from which the issue was reported, type of users accessing the application when the issue was reported, details about the application, and details about machines on which the application was being accessed. Additionally, the activity logs may include at least one of attributes of each source of the plurality of the sources, name of an executed function, parameters associated with the executed function, stack traces, name of module, and name of user.

Upon obtaining the activity logs, the data collection module 210 may append the activity logs to the database 108. In some implementation, besides appending the activity logs to the database 108, the data collection module 210 may simultaneously save the activity logs in the report generation data 222 of the system 102. Further, the activity logs are processed by the data processing module 212 using a decision tree. In an implementation, the decision tree is configured to output a category of each issue in the activity log and a priority score associated with each issue. The priority score may be indicate a criticality of the issue. For example, business critical issues may be provided a high priority score as compared to other issues. Specifically, an issue associated with a payment interface may be considered critical and may be provided a high score. For the purpose of scoring, the decision tree may be trained based on the business processes of an organization, so that the scoring of the issue may be apt. For example, business processes in a medical industry is different from business process in technology industry, and hence respective issues need to be scored accordingly.

Further, for issue in the activity log, the data processing module 212 identifies relevant resources to resolve the issues based on the category of the issue, the priority score associated with the issue, and the attributes of the relevant resources. The term ‘resource’ used herein may be understood as a member of a team or an entire team equipped with knowledge about the business processes and applications, and capable of addressing the issues in the activity logs. Specifically, the term ‘resource’ may indicate a person assigned for a project and/or a specific functional module associated with the business process. Further, in an embodiment, the attributes include historical issue resolution data. Issues resolved in the past, time taken to resolve the issues, and complexity of the issues may together define the historical issue resolution data of the resource.

The data processing module 212 may store the historical issue resolution data and associated resource's identity in the issue resolution data 220. As described earlier, the system 102 is communicably coupled to the resource devices 110 through the network 106. As such, the data processing module 212 may determine the availability and attributes of resources from the respective resource devices 110. For the purpose of gathering the attributes from the resource device 110, in an implementation, each resource device 100 may be configured to automatically store information pertaining to issues handled, nature of the issues, and resolution time. In another implementation, applications capable of tracking and storing the attributes of each resource may be made available in the resource device 110. Once the resource logs-in to the resource device 110, the application may be triggered to capture the activities of the resource related to resolving assigned issues and training taken to gather knowledge for resolving the assigned issues. Such information may enhance the attributes of the resource stored in the resource device 110. In one implementation, the data processing module 212 may be configured to map the category of the issue with nature of issues handled by the resource in. Such mapping helps to identify the appropriate and relevant resource for resolving the issue reported in the activity logs. It will be understood by a person skilled in the art that, based on the criticality of the issue, the data processing module 212 may identify one or more resources, where each resource belongs to a different team, such as testing team, development team, production team, and the like.

Furthermore, the access to online calendar of the resources may provide the availability status of the resources. To that end, the data processing module 212 may be configured to identify relevant resources for resolving the issues in the activity logs. In an implementation, the triage activity module 214 determines a triage activity based on the availability of the identified relevant resources, the category of the issues, and the priority scores associated with the issues. The triage activity includes a sequence for resolving the issues, where the sequence is determined based on the priority scores associated with the issues and the availability of the relevant resources.

For instance, when the priority score of an issue is high and the availability of identified relevant resources is confirmed, the issue may be listed at a top of a triage list. Issues associated with competitively low priority score and unavailability of the relevant resources may follow thereafter in the triage list. Once the triage activity is defined, based on the availability of the identified relevant resources, the triage activity module 214 schedules a call, for a predetermined time duration, to include all the relevant resources. In an embodiment, the time duration of the call may be predetermined by the triage activity module 214 based on the attributes of the relevant resources.

For example, an experienced resource who has resolved similar issues in the past and known to handle complex issues may require less time to understand background of the issues and resolve them. As such, time duration required by such resource may be less. However, parameters for determining the time duration for scheduling the call should not be limited to the example embodiments described herein. The triage activity module 214 also send invites, regarding the scheduled call, to all the identified relevant resources based on their respective availabilities, where such invites may notify the time duration of the call.

In another implementation, the triage activity module 214 may continuously monitor the availability of the relevant resources. Any change in availability status of the relevant resources may lead to change in the sequence of the issues in the triage activity. With such arrangement, often, issues with low priority score may also be sequenced up in the list of issues only based on the availability of the relevant resources. On the contrary, issues may also be sequenced later in the list of issues when the availability status of the relevant resource changes from ‘availability’ to ‘not available’ during a specific time slot. For issues associated with high priority score, the triage activity module 214 may notify the relevant resources about the criticality of the issue, through the invite, so that the resources make prioritize this issue resolution over other activities. In cases where the scheduled call is declined by the resources, the triage activity module 214 may be configured to determine next closest available time slot from the resource devices 110 to reschedule the call.

In an implementation, the triage activity module 214 also generates a report for the triage activity. The report includes real time information related to the obtained activity logs, the plurality of sources, and the sequence of the issues. For instance, any change in log data, transactions, and/or any changes to the issues reported in the already existing activity logs may be appended to the activity logs on a real-time basis with the aid of connectors. For example, additional information gathered regarding the application from which the issue was reported may be appended to the activity logs on real-time basis. Thus, the report generated by the triage activity module 214 at the time of scheduling the call may include real-time information about the issues, thereby making the triage activity and resolution of the issues interactive and easy. In an implementation, the triage activity module 214 may utilise the information stored in the report generation data 222 to generate the report. Additionally, the generated report may also be stored in the database 108 and the report generation data 102. This helps the resource devices 110 to access the required information from the database 108 through the network 106. Particularly, the reports saved in the report generation data 102 may be used to generate reports in future relating to similar issues.

Furthermore, the triage activity module 214 executes a service module on a client machine associated with the user. Here, the phrase ‘client machine’ may be understood as the user devices 104 which are configured to facilitate operation of the business application installed therein or enable access to server hosted business applications through the network 106.

As used herein, the phrase ‘service module’ may be understood as a cluster of steps prepared by the relevant resources to resolve the issues in the business applications. Upon the execution, the triage activity module 214 may continuously monitor activities performed by the user on the user devices 104, to retrieve data from a registry of the user device 104 based on a predefined set of parameters. In an example, the predefined set of parameters include at least one of information related to software installed on the client machine, frequency of usage of the software installed on the client machine, registry of the client machine, keywords used in each software installed on the client machine, domain of the client machine, services running on the client machine, and metadata associated with the software installed on the client machine. In an implementation, the data retrieved from the registry of the client machine comprises information relating to domain associated to the user. Preferably, the domain may belong to an organization, directory, and users. The domain information may be used to establish relation between the organization and the user.

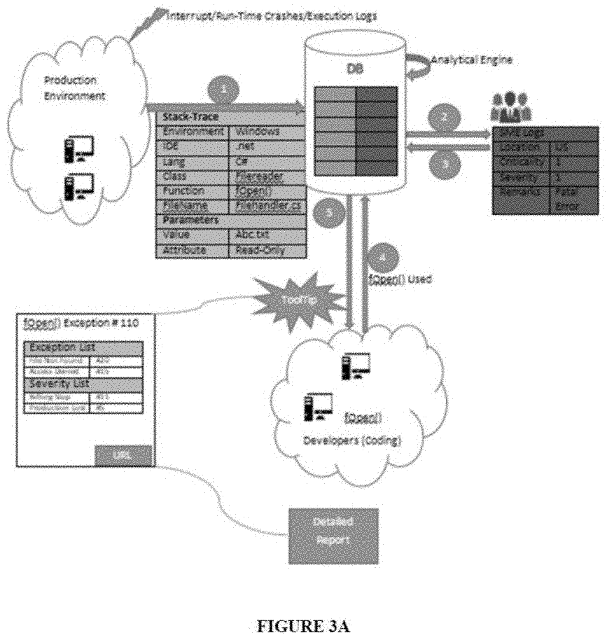

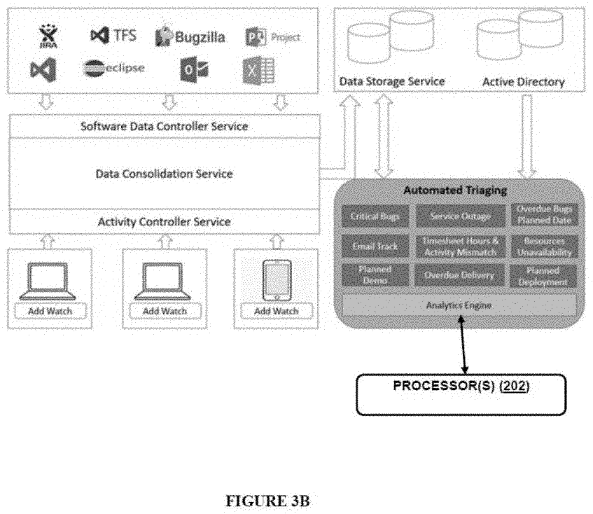

In an example embodiment, referring to FIG. 3A and FIG. 3B in combination, triage management through the system 102 is illustrated. In step 1, as part of data collection service by the proposed system 102, the data will be collected from the one or more systems running in server and machine network environment.

Each of the system may have a service running on the system for identifying each of an area, module, users and application. The data collection module 210 collect the data (Environment related information's (OS, Service Packs, Kb Articles, System variables values), Function name, Parameters, Stack traces, module name, user name working on tools etc.) and push the data to the predefined DB in the network or the Server.

In step 2 of FIG. 3A, as part of analytical service, the processor 202 provides the analytical service for scheduling calls and invitees. In an implementation, analytical engine, coupled with the processor 202 (as shown in FIG. 3B) helps to categories and map user activities based on each of the classifications and decision tree results, in addition to historical records.

In step 3 of FIG. 3A, the system 102 provides triaging service (also referred as Automated triaging service) through an analytical engine to help in deciding and searching an appropriate activity task in respect to a correct owner. The analytical engine may be executed by the processor 202. The automated triaging service is configured help at the time of triaging to process and visualize data in near real time manner to make triaging more interactive. Automated Triaging Service through the system 102 is responsible for each of the schedule call, identify and invite attenders, manage and define time slots to complete triaging process.

In step 4 of FIG. 3A, detailed reporting through the system 102 as discussed above is shown. In an implementation, the system 102 provides near real time visualization and reporting, to identify root cause of the issues besides mapping the details of activity with the relevant resources. Table 1 below shows exemplary format of detailed reporting through the system 102:

TABLE 1

| Module | Sub-module | | | | | | | | | |
|---|---|---|---|---|---|---|---|---|---|---|
| name | name | Func | Cls | Env | Strace | Platform | Lang | File | FileLoc | abcID |
| Login | Login | FOpen | File | Win | 0x.. | .net | C | Login.cpp | ...C:\TestLib\ | abc@habc.com |
| | authorization | ( ) | handling | 2K8 | 879 | | # | | | |
| Account | Account | X.ToString | String | Win | 0x.. | .net | C | Auth.cpp | -- | Abc1@habc.com |
| | payable | ( ) | | 7 | 457 | | # | | C:\StringsProg\ | |

In step 5 of FIG. 3A, the affinity data service through the proposed system is shown 102. As discussed above, the service component may be executed on the client machine associated to the user. The service component analyses the client machine based on the set of parameters in order to retrieve data.

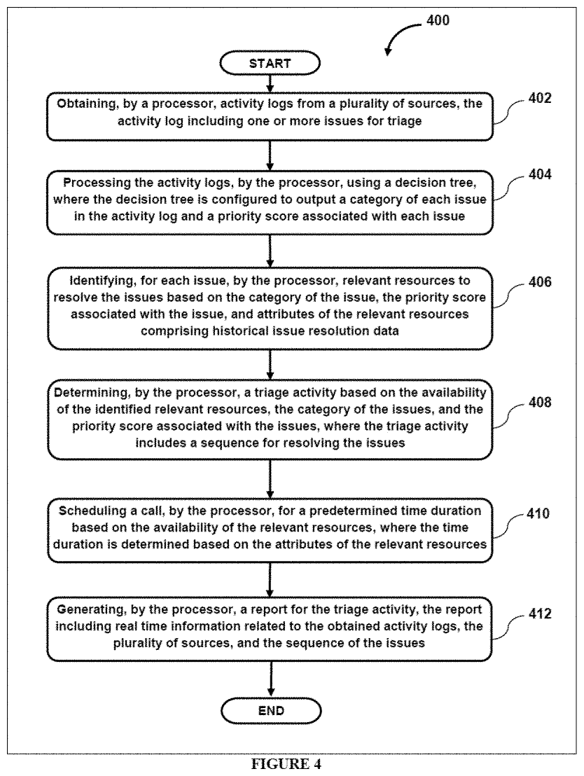

Referring now to FIG. 4, a method 400 for triage management, is disclosed in accordance with an embodiment of the present subject matter. The method 400 may be described in the general context of computer executable instructions. Generally, computer executable instructions can include routines, programs, objects, components, data structures, procedures, modules, functions, and the like, that perform predefined functions or implement abstract data types. The method 400 may also be practiced in a distributed computing environment where functions are performed by remote processing devices that are linked through a communications network. In a distributed computing environment, computer executable instructions may be located in local and remote computer storage media, including memory storage devices.

The order in which the method 400 is described is not intended to be construed as a limitation, and any number of the described method blocks can be combined in any order to implement the method 400 or alternate methods. Additionally, individual blocks may be deleted from the method 400 without departing from the spirit and scope of the subject matter described herein. Furthermore, the method 400 can be implemented in any suitable hardware, software, firmware, or combination thereof. However, for ease of explanation, in the embodiments described below, the method 400 may be implemented by the above described system 102. Specifically, the method 400 may be executed by the processor 202 of the system 102.

At block 402, the method 400 includes obtaining activity logs from a plurality of sources. In an example, the sources may include, but not limited to, identity management units, project management units, applications, web servers, and database. The activity log includes one or more issues for triage. In some embodiments, the activity log may also include at least one of an attribute of each source of the plurality of the sources, name of an executed function, parameters associated with the executed function, stack traces, name of module, and name of user. In an implementation, the method 400 at block 402 may also include appending the obtained activity logs to the database 108.

At block 404, the method 400 includes processing the activity logs using a decision tree. According to a preferred implementation, the decision tree is configured to output a category of each issue in the activity log and a priority score associated with each issue. As described earlier, the phrase ‘priority score’ may be indicative of criticality of the issue to the business processes.

At block 406, the method 400 includes identifying, for each issue, relevant resources to resolve the issue based on the category of the issue, the priority score associated the issue, and attributes of the relevant resources. In an embodiment, the attributes of the relevant resources may include historical issue resolution data.

At block 408, the method 400 includes determining the triage activity based on availability of the identified relevant resources, the categories of the issues, and the priority scores associated with the issues. In an embodiment, the triage activity includes the sequence for resolving the issues and the sequence may be determined based on the priority scores associated with the issues and the availability of the relevant resources.

At block 410, the method 400 includes scheduling the call for a predetermined time duration based on the availability of the relevant resources. The time duration for the call may be determined based on the attributes of the relevant resources. The method 400 at the block 410 may further include sending invites to the identified relevant resources based on the availability of the relevant resources.

At block 412, the method 400 includes generating the report for the triage activity. The report includes real time information related to the obtained activity logs, the plurality of sources, and the sequence of the issues.

Although not explicitly shown in blocks of FIG. 4, the method 400 includes executing the service module on the client machine, such as the user devices 104, associated with the user. The method 400 further includes continuously monitoring activities performed by the user on the client machine to retrieve data from the registry of the client machine based on the predefined set of parameters. In an implementation, the predefined set of parameters may include at least one of information related to software installed on the client machine, frequency of usage of the software installed on the client machine, registry of the client machine, keywords used in each software installed on the client machine, domain of the client machine, services running on the client machine, and metadata associated with the software installed on the client machine. Furthermore, the data retrieved from the registry of the client machine may include information relating to the domain associated to the user, where the domain is used to establish the relation between the organization and the user.

Exemplary embodiments discussed above may provide certain advantages. Though not required to practice aspects of the disclosure, the advantages may include those provided by the following features.

Some embodiments of the system and the method aid in optimizing the entire triage activity or triage process. Since the system 102 is capable of automatically obtaining information related to activity logs from multiple sources, identify the relevant resources to resolve the issues reported in the activity logs, the system 102 and the method 400 allow for automating scheduling of triage calls, which is otherwise handled as a labour-intensive manual task. Owing to these capabilities, the system 102 and the method 400 provides to efficiently manage the triage activity and resolution of the issues with minimum or no human intervention. Therefore, the system 102 and the method 400 provide a cost-effective solution to automate the entire triage activity.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

1. A method for triage management, the method comprising:
obtaining, by a processor, activity logs from a plurality of sources, each activity log comprising one or more issues for triage;
processing the activity logs, by the processor, using a decision tree, wherein the decision tree is configured to output a category of each issue in the activity log and a priority score associated with each issue, the priority score being indicative of a criticality of the issue;
identifying, by the processor, for each issue, relevant resources to resolve the issue based on the category of the issue, the priority score associated with the issue, and attributes of the relevant resources comprising historical issue resolution data;
determining, by the processor, a triage activity based on availability of the identified relevant resources, the categories of the issues, and the priority scores associated with the issues, wherein the triage activity comprises a sequence for resolving the issues, and wherein the sequence is determined based on the priority scores associated with the issues and the availability of the relevant resources;
scheduling a call, by the processor, for a predetermined time duration based on the availability of the relevant resources, wherein the predetermined time duration is determined based on the attributes of each of the relevant resources; and
generating, by the processor, a report for the triage activity, the report comprising real time information related to the obtained activity logs, the plurality of sources, and the sequence of the issues.

2. The method as claimed in claim 1 comprising:
executing, by the processor, a service module on a client machine associated with a user; and
continuously monitoring, by the processor, activities performed by the user on the client machine to retrieve data from a registry of the client machine, based on a predefined set of parameters.

3. The method as claimed in claim 1, wherein scheduling the call comprises: sending invites, by the processor, to the identified relevant resources based on the availability of the relevant resources.

4. The method as claimed in claim 1 comprising:
appending to a database, by the processor, at least one of the obtained activity logs, the generated report, and metadata associated with each issue.

5. The method as claimed in claim 1, wherein the plurality of sources comprises at least one of identity management units, project management units, user-end-applications, and web server.

6. The method as claimed in claim 1, wherein the obtained activity logs comprises at least one of attributes of each source of the plurality of the sources, name of an executed function, parameters associated with the executed function, stack traces, name of module, and name of user.

7. The method as claimed in claim 2, wherein the predefined set of parameters comprises at least one of information related to software installed on the client machine, frequency of usage of the software installed on the client machine, registry of the client machine, keywords used in each software installed on the client machine, domain of the client machine, services running on the client machine, and metadata associated with the software installed on the client machine.

8. The method as claimed in claim 2, wherein the data retrieved from the registry of the client machine comprises information relating to a domain associated to the user.

9. A system for triage management, the system comprising: a
memory; and
a processor coupled to the memory, wherein the processor is configured to execute instructions stored in the memory, and wherein the processor is configured to:
obtain activity logs from a plurality of sources, each activity log comprising one or more issues for triage;
processing the activity logs using a decision tree, wherein the decision tree is configured to output a category of each issue in the activity log and a priority score associated with each issue, the priority score being indicative of a criticality of the issue;
identify, for each issue, relevant resources to resolve the issue based on the category of the issue, the priority score associated with the issue, and attributes of the relevant resources comprising historical issue resolution data;
determine a triage activity based on availability of the identified relevant resources, the categories of the issues, and the priority scores associated with the issues, wherein the triage activity comprises a sequence for resolving the issues, and wherein the sequence is determined based on the priority scores associated with the issues and the availability of the relevant resources;
schedule for a predetermined time duration based on the availability of the relevant resources, wherein the predetermined time duration is determined based on the attributes of each of the relevant resources; and
generate a report for the triage activity, the report comprising real time information related to the obtained activity logs, the plurality of sources, and the sequence of the issues.

10. The system as claimed in claim 9, wherein the processor is configured to: execute a
service module on a client machine associated with a user; and continuously
monitor activities performed by the user on the client machine to retrieve data from a registry of the client machine, based on a predefined set of parameters.

11. The system as claimed in claim 9, wherein the processor is configured to send invites to the identified relevant resources based on the availability of the relevant resources, to schedule the call.

12. The system as claimed in claim 9, wherein the processor is configured to append at least one of the obtained activity logs, the generated report, and metadata associated with each issue, to a database.

13. The system as claimed in claim 9, wherein the plurality of sources comprises at least one of identity management units, project management units, user-end-applications, and web server.

14. The system as claimed in claim 9, wherein the obtained activity logs comprises at least one of attributes of each source of the plurality of the sources, name of an executed function, parameters associated with the executed function, stack traces, name of module, and name of user.

15. The system as claimed in claim 10, wherein the predefined set of parameters comprises at least one of information related to software installed on the client machine, frequency of usage of the software installed on the client machine, registry of the client machine, keywords used in each software installed on the client machine, domain of the client machine, services running on the client machine, and metadata associated with the software installed on the client machine.

16. The system as claimed in claim 9, wherein the data retrieved from a registry of the client machine comprises information relating to a domain associated to the user.
